(19) United States
(12) Patent Application Publication
(10) Pub. No.: US 2020/0316968 A1
(43) Pub. Date: Oct. 8, 2020

(54) THERMAL PRINTER

(71) Applicant: MITSUBISHI ELECTRIC CORPORATION, Tokyo (JP)

(72) Inventor: Makoto SAKUWA, Tokyo (JP)

(73) Assignee: MITSUBISHI ELECTRIC CORPORATION, Tokyo (JP)

(21) Appl. No.: 16/758,304

(22) PCT Filed: Jan. 11, 2018
(86) PCT No.: PCT/JP2018/000456

§ 371 Date: Apr. 22, 2020

(51) Int. Cl. B41J 11/70; B41J 2/32; B41J 15/04; B41J 11/00; B41J 29/02

(52) U.S. Cl. CPC B41J 11/70; B41J 2/32; B41J 29/02; B41J 11/0095; B41J 11/0085; B41J 15/04

(57) ABSTRACT

An object of the present invention is to provide a thermal printer having a paper feed mechanism capable of readily loading paper pulled out from a roll of paper and capable of readily feeding sheets of paper. A first housing is capable of coupling to and decoupling from a second housing. The first housing includes a paper edge severance guide unit configured to sever a leading edge of the sheet of paper from a roll state of the rolled paper, and guide the sheet of paper toward the platen roller, feed rollers configured to perform gripping of the sheet of paper and conveyance of the sheet of paper in the direction of the platen roller, and a paper stopper configured to block a passage for transporting the sheet of paper in a state where the first housing is decoupled from the second housing.

### TECHNICAL FIELD

The present invention relates to a paper feed mechanism of a thermal printer.

### BACKGROUND ART

In thermal printers for business use with a large number of printed sheets, large-capacity rolled paper in a rolled state is used so that the frequency of replacing paper used for printing can be reduced. In a conventional thermal printer, the paper feed mechanism has been proposed in which a feed roller is disposed at a front surface of an opening portion of a paper feeding mechanism for feeding sheets of paper pulled out from the loaded rolled paper so that the sheets of paper are readily fed; thereby, the sheets of paper are readily inserted into a feed roller after the rolled paper is loaded (for example, see Patent Document 1).

### PRIOR ART DOCUMENTS

### Patent Documents

[Patent Document 1] Japanese Patent Application Laid-Open No. 1-187133

### SUMMARY

### Problem to be Solved by the Invention

However, in a conventional thermal printer, a plurality of feed rollers are collectively disposed in the vicinity of the opening portion; therefore, figuring out where to pass through a sheet of paper is not easy. Accordingly, it takes time to find a feed roller corresponding to each sheet of paper. In addition, a plurality of feed rollers are collectively disposed in the vicinity of the opening portion; therefore, a sheet of paper may be loaded on an inappropriate feed roller instead of on the feed roller corresponding to each sheet of paper.

In view of the above, an object of the present invention is to provide a thermal printer having a paper feed mechanism capable of readily loading paper pulled out from rolled paper and capable of readily feeding sheets of paper.

### Means to Solve the Problem

According to the present invention, the thermal printer includes a thermal head configured to record an image on a sheet of paper pulled out from rolled paper wound in a roll shape, a platen roller disposed at a position facing the thermal head, and sandwiches the sheet of paper with the thermal head, a first housing in which the platen roller is disposed, and a second housing in which the thermal head is disposed. The first housing is capable of coupling to and decoupling from the second housing. The first housing includes a paper edge severance guide unit configured to sever a leading edge of the sheet of paper from a roll state of the rolled paper, and guide the sheet of paper toward the platen roller, feed rollers disposed between the paper edge severance guide unit and the platen roller, and configured to perform gripping of the sheet of paper and conveyance of the sheet of paper in the direction of the platen roller, and a paper blocking unit disposed between the feed rollers and the platen roller and configured to block a passage for transporting the sheet of paper in a state where the first housing is decoupled from the second housing.

### Effects of the Invention

According to the present invention, the user can readily load the paper pulled out from the rolled paper, and can readily feed the paper.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 An explanatory diagram of a configuration of a thermal printer according to Embodiment 1.

FIG. 2 An explanatory diagram of the configuration of the thermal printer according to Embodiment 1.

FIG. 3 A block diagram of the thermal printer according to Embodiment 1.

FIG. 4 A perspective view of a paper feed mechanism of the thermal printer according to Embodiment 1.

FIG. 5 A front view of the paper feed mechanism of the thermal printer according to Embodiment 1.

FIG. 6 A schematic cross-sectional view of the paper feed mechanism of the thermal printer according to Embodiment 1.

FIG. 7 A flowchart of paper feed operation of the thermal printer according to Embodiment 1.

FIG. 8 A cross-sectional view of a paper edge severance guide unit of the thermal printer according to Embodiment 1.

FIG. 9 An explanatory diagram of severance guide operation for a paper edge of the thermal printer according to Embodiment 1.

FIG. 10 An explanatory diagram the severance guide operation for a paper edge of the thermal printer according to Embodiment 1.

FIG. 11 An explanatory diagram of blocking operation for paper of the thermal printer according to Embodiment 1.

FIG. 12 An explanatory diagram of the blocking operation for paper of the thermal printer according to Embodiment 1.

FIG. 13 An explanatory diagram of the blocking operation for paper of the thermal printer according to Embodiment 1.

FIG. 14 A perspective view of a part of the paper feed mechanism illustrating paper grip operation of the thermal printer according to Embodiment 1.

FIG. 15 An explanatory diagram of a configuration of the thermal printer according to Embodiment 2.

FIG. 16 A block diagram of the thermal printer according to Embodiment 2.

FIG. 17 A flowchart of paper feed operation of the thermal printer according to Embodiment 2.

### DESCRIPTION OF EMBODIMENTS

### Embodiment 1

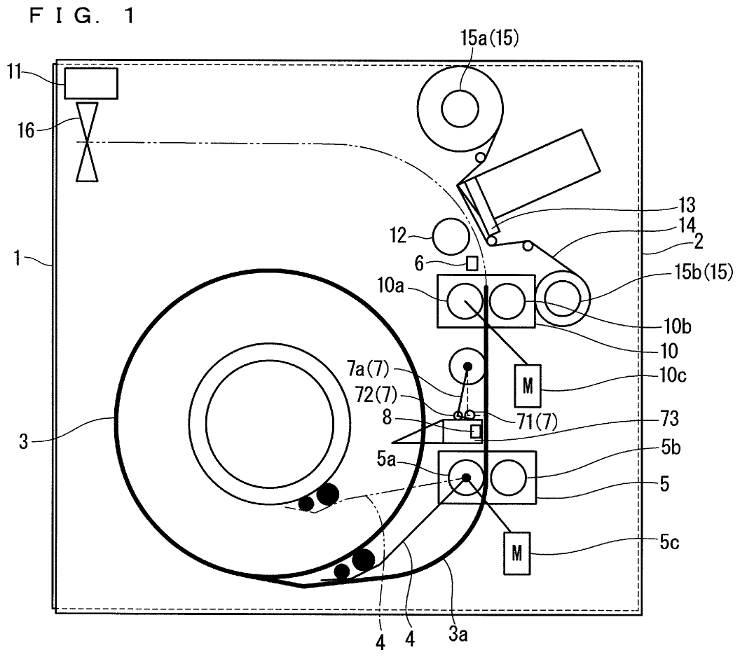

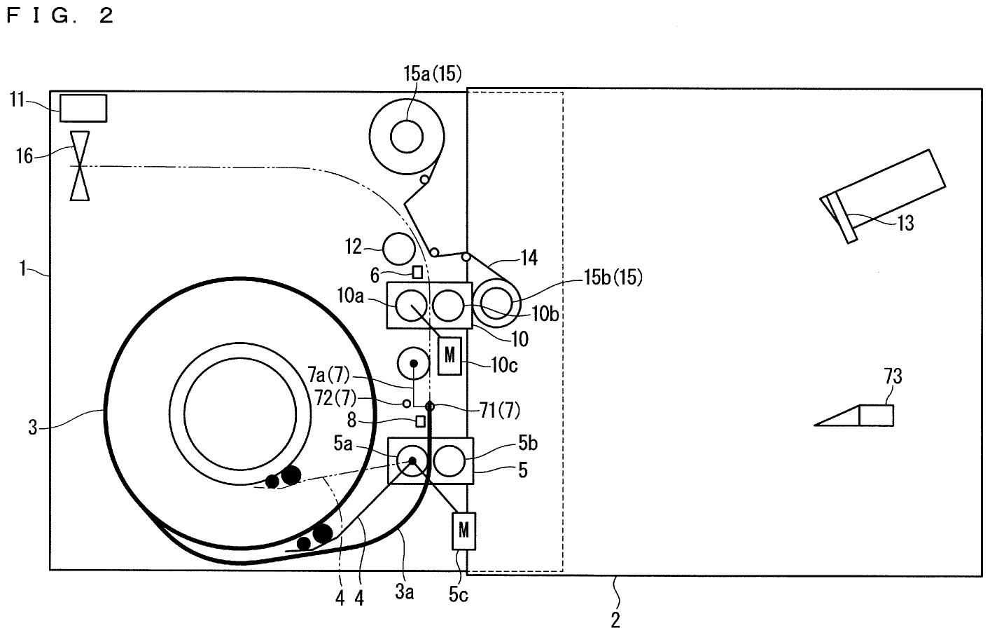

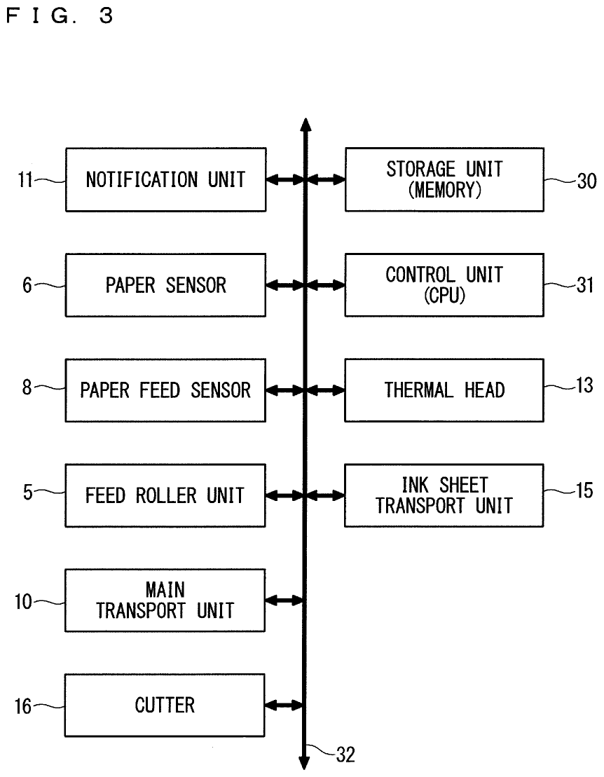

Hereinafter, Embodiment 1 of the present invention is described with reference to the drawings. FIG. 1 and FIG. 2 are explanatory diagrams of a configuration of the thermal printer according to Embodiment 1. Specifically, FIG. 1 is the explanatory diagram illustrating a state where a housing 1 is coupled to a housing 2. FIG. 2 is the explanatory diagram illustrating a state where a housing 1 is decoupled from a housing 2. FIG. 3 is a block diagram of the thermal printer.

(Configuration)

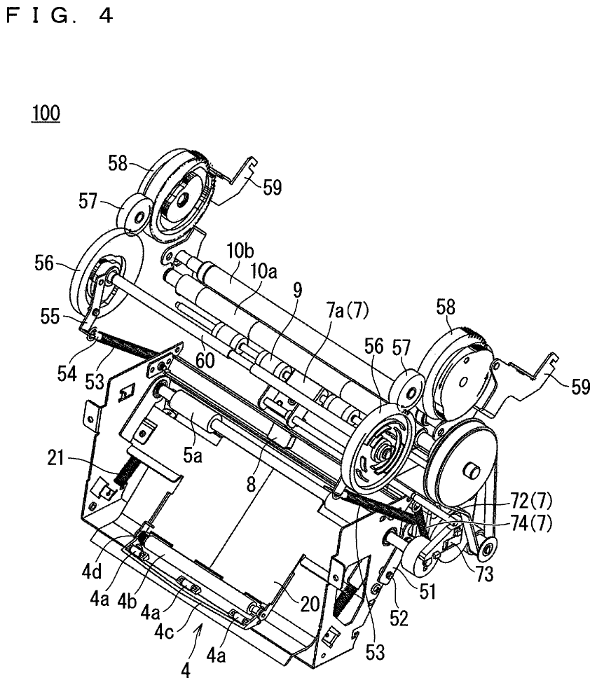

First, the configuration of the thermal printer according to Embodiment 1 will be described. As illustrated in FIGS. 1 to 3, the thermal printer includes a thermal head 13, a platen roller 12, the housing 1 as a first housing, and the housing 2 as a second housing. The thermal printer also includes a paper feed mechanism 100 (see FIG. 4), and details of the paper feed mechanism 100 will be described later.

The thermal head 13 records an image on a sheet of paper 3a pulled out from rolled paper 3 wound in a roll shape. The platen roller 12 is disposed at a position facing the thermal head 13, and sandwiches the sheet of paper 3a with the thermal head 13.

Inside the housing 1, the platen roller 12 and a slide mechanism (not shown) are disposed. The dimension of the housing 1 is slightly smaller than that of the housing 2 and the housing 1 can be housed inside the housing 2. The slide mechanism provided in the housing 1 allows the housing 1 to slide the horizontal direction with respect to the housing 2 to couple the housing 1 to the housing 2 as illustrated in FIG. 1 and as illustrated in FIG. 2, the slide mechanism allows the housing 1 to be pulled out of the housing 2 to decouple the housing 1 from the housing 2. This structure is thus configured to facilitate the replacement of such media as an ink sheet 14 and the rolled paper 3 and maintenance of the media.

Note that, in Embodiment 1, although, an example in which the housing 1 includes a slide mechanism is described, the housing 1 may include a door structure and the housing 1 rotates with respect to the housing 2 so that the housing 1 is coupled to the housing 2 or the housing 1 is decoupled.

As illustrated in FIGS. 1 to 3, the housing 1 further includes a rolled paper storage unit (not shown) for storing the rolled paper 3, a paper edge severance guide unit 4, a feed roller unit 5, and a paper feed sensor 8 as a paper detection unit, a paper stopper 7 as a paper blocking unit, a main transport unit 10, an ink sheet transport unit 15, a cutter 16, and a notification unit 11.

The paper edge severance guide unit 4 severs the leading edge of the sheet of paper 3a from the rolled paper 3 in a roll state, and guides the sheet of paper 3a toward the platen roller 12. The feed roller unit 5 includes feed rollers 5a that are driven to rotate by a feed motor 5c, and a grip roller 5b that holds the sheet of paper 3a between the feed rollers 5a and thereof. The feed rollers 5a are disposed between the paper edge severance guide unit 4 and the platen roller 12, and performs gripping of the sheet of paper 3a and conveyance of the sheet of paper 3a in the direction of the platen roller 12.

The paper stopper 7 is disposed between the feed rollers 5a and the platen roller 12, and blocks a passage for transporting the sheet of paper 3a in a state where the housing 1 is decoupled from the housing 2. The paper feed sensor 8 is disposed in the vicinity of the paper stopper 7, more specifically, on the front side of the paper stopper 7 in the passage, and detects the leading edge of the sheet of paper 3a. The main transport unit 10 includes a grip roller 10a that is driven to rotate by a transport motor 10c, and a pinch roller 10b that sandwiches the sheet of paper 3a with the grip roller 10a, and mainly transports the sheet of paper 3a.

The ink sheet transport unit 15 includes an ink sheet supply unit 15a that supplies the ink sheet 14 between the thermal head 13 and the platen roller 12, and an ink sheet winding unit 15b that collects the supplied ink sheet 14. The cutter 16 is disposed downstream of the passage and cuts the printed sheet of paper 3a into a predetermined size. The notification unit 11 notifies completion of the feeding of the sheet of paper 3a based on the detection of the paper feed sensor 8.

As illustrated in FIGS. 1 to 3, the housing 2 further includes a slide cam 73, a storage unit 30, a control unit 31, and a power supply unit (not shown). The slide cam 73 comes into contact with a rotation lever 72 provided in the paper stopper 7. The storage unit 30 includes a nonvolatile memory such as a flash memory and a temporary storage memory such as a RAM, and stores a program for controlling the entire thermal printer and initial setting values thereof. The control unit 31 controls the overall operation of the thermal printer according to a program stored in the storage unit 30 that is composed of a CPU or the like.

As illustrated in FIG. 3, the notification unit 11, a paper sensor 6, the paper feed sensor 8, the feed roller unit 5, the main transport unit 10, the cutter 16, the storage unit 30, the control unit 31, the thermal head 13, and the ink sheet transport unit 15 are interconnected through a bus 32.

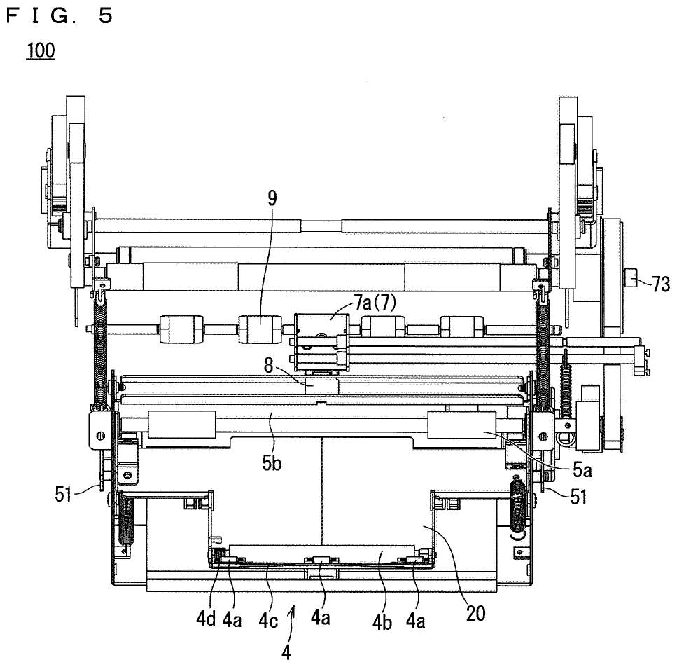

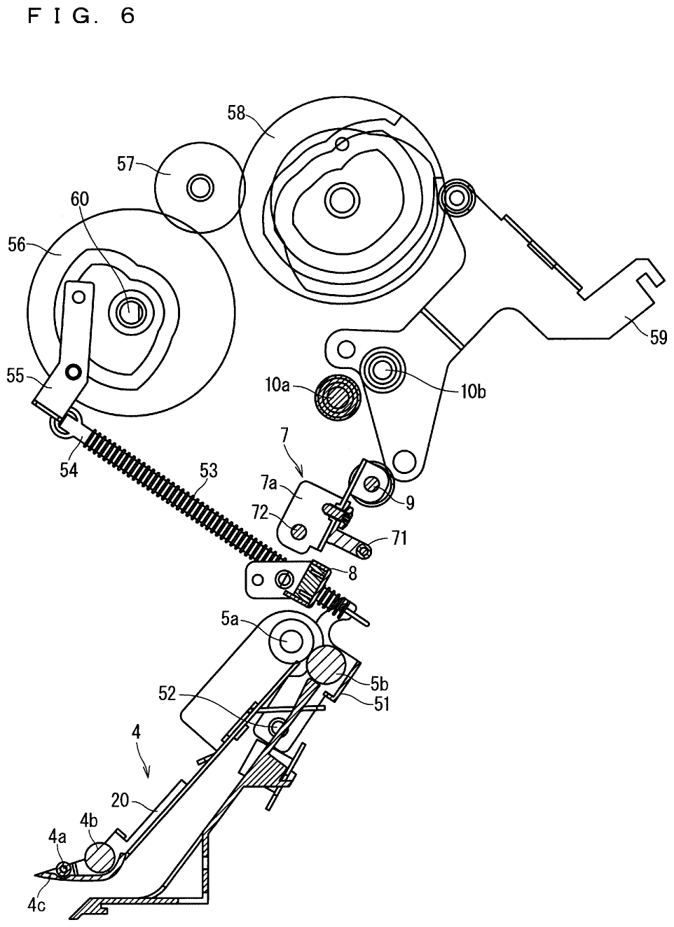

Next, the configuration of the paper feed mechanism 100 of the thermal printer will be described with reference to FIGS. 4 to 6. FIG. 4 is a perspective view of the paper feed mechanism 100. FIG. 5 is a front view of the paper feed mechanism 100. FIG. 6 is a schematic cross-sectional view of the paper feed mechanism 100.

As illustrated in FIGS. 4 to 6, the paper feed mechanism 100 includes the paper edge severance guide unit 4, the paper stopper 7, the paper feed sensor 8, and the feed roller section 5, and is provided inside the housing 1 having a slide mechanism.

Further, individual components of the paper feed mechanism 100 will be described in detail. The paper edge severance guide unit 4 includes a guide 20, three small rollers 4a, a large roller 4b, a severance guide 4c, and urging springs 21. The guide 20 is swingable around the axis of the feed rollers 5a as a swing fulcrum. The urging springs 21 urge the guide 20 in a direction to approach the rolled paper 3. The large roller 4b is disposed at the distal end portion of the guide 20. The severance guide 4c is provided on the guide 20 via the axis of the large roller 4b, and is swingable around the axis of the large roller 4b as a swing fulcrum. The three small rollers 4a are disposed in parallel at the distal end portion of the severance guide 4c.

Note that the guide 20 corresponds to a first arm, and the severance guide 4c corresponds to a second arm. Further, the three small rollers 4a correspond to a plurality of second rollers, and the urging spring s21 correspond to second urging springs.

The paper stopper 7 includes a main body 7a, a small roller 71, a rotating lever 72, and an urging spring 74. The main body 7a is rotatably provided on the axis of a guide roller 9, and the small roller 71 is provided at the distal end portion of the main body 7a. The main body 7a is provided with the rotating lever 72, and the rotating lever 72 and the main body 7a are turned by moving the turning lever 72 up and down. Note that, the small roller 71 corresponds to a first roller, and the urging spring 71 corresponds to a first urging spring.

The slide cam 73 provided on the housing 2 comes into contact with one end of the rotation lever 72, so that the rotation lever 72 can move up and down. The configuration is that the slide cam 73 comes into contact with the rotating lever 72 by the housing 1 coupling to the housing 2.

The paper feed sensor 8 is disposed between the feed rollers 5a and the small roller 71 provided at the distal end portion of the main body 7a. Further, as illustrated in FIG. 2, when detecting the leading edge of the sheet of paper 3a, the paper feed sensor 8 notifies the control unit 31 of the detection, and the control unit 31 causes the notification unit 11 to generate an alarm sound.

As illustrated in FIGS. 4 to 6, a grip roller 5b is disposed to face the feed rollers 5a, and the grip roller 5b is held by left and right pressing metal plates 51 and is rotatably locked at a rotation fulcrum 52. Further, ends of the left and right pressing metal plates 51 opposite to the rotation fulcrum 52 are connected to one ends of the urging springs 53, and the left and right pressing metal plates 51 are urged by the urging springs 53. The urging spring 53 is a coil spring, and a lever shaft 54 is disposed inside the urging spring 53. The other end of the urging spring 53 is connected to a cam 56 via a cam follower 55. The cam 56 is rotatable by a DC motor (not shown). Further, the cam 56 is connected to a pinch cam 58 via an idle gear 57, and a pinch roller 10b is rotatably connected to the pressing metal plate 59. Also, in order to synchronize the left and right pressing metal plates 51 and the left and right pressing metal plates 59, the structure is that the left and right pressing metal plates 51 and the left and right pressing metal plates 59 are connected left and right thereof by a synchronization shaft 60 and is integrally operable.

(Operation)

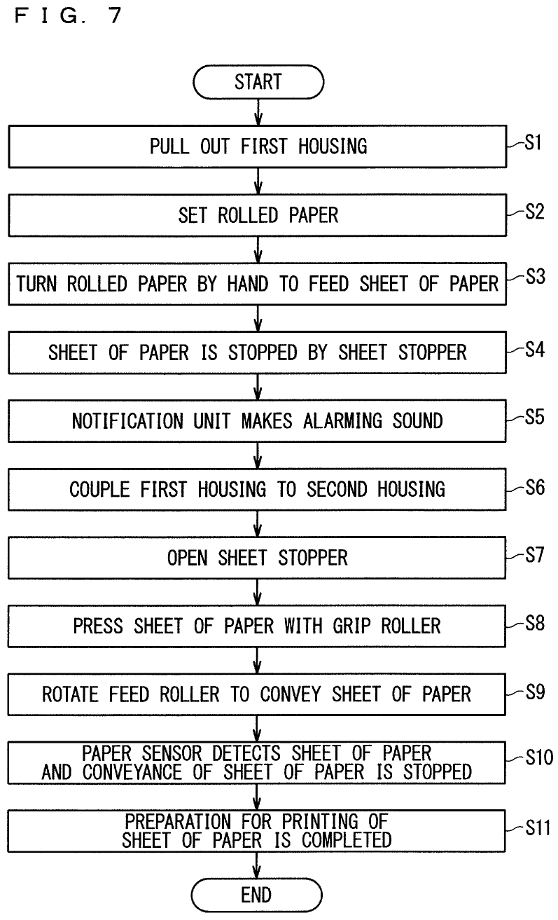

Next, a paper feed operation flow according to Embodiment 1 will be described with reference to FIG. 7. FIG. 7 is a flowchart of the paper feed operation of the thermal printer. As illustrated in FIG. 7, first, the user pulls out the housing 1 from the housing 2 to decouple the housing 1 from the housing 2 (Step S1). By this decoupling operation, the paper stopper 7 is closed, and the passage for transporting the sheet of paper 3a is blocked off. Next, the user sets the rolled paper 3 in the roll paper storage unit (Step S2). Next, the user turns the rolled paper 3 by hand to feed the sheet of paper 3a (Step S3). Then, the user moves the sheet of paper 3a until the sheet of paper 3a is stopped by the sheet stopper 7 (Step S4). Thus, the loading of the sheet of paper 3a is completed. At this time, the paper feed sensor 8 detects the leading edge of the sheet of paper 3a, and the notification unit 11 notifies the user of completion of paper feeding by making an alarming sound, that is, performs notification of completion of paper loading (Step S5).

Next, the user pushes the housing 1 to make a coupling with the housing 2 (Step S6). The sheet stopper 7 is opened by this coupling operation, and a passage for transporting the sheet of paper 3a is opened (Step S7). Next, the control unit 31 presses the sheet of paper 3a with the grip roller 5b (Step S8), and rotates the feed rollers 5a to convey the sheet of paper 3a (Step S9). After the sheet of paper 3a passes between the grip roller 10a and the pinch roller 10b and the leading edge of the sheet of paper 3a is detected by the paper sensor 6, the control unit 31 stops conveying the sheet of paper 3a (Step S10), and preparation for printing of the sheet of paper 3a is completed (Step S11). Thus, the feeding of the sheet of paper 3a is completed.

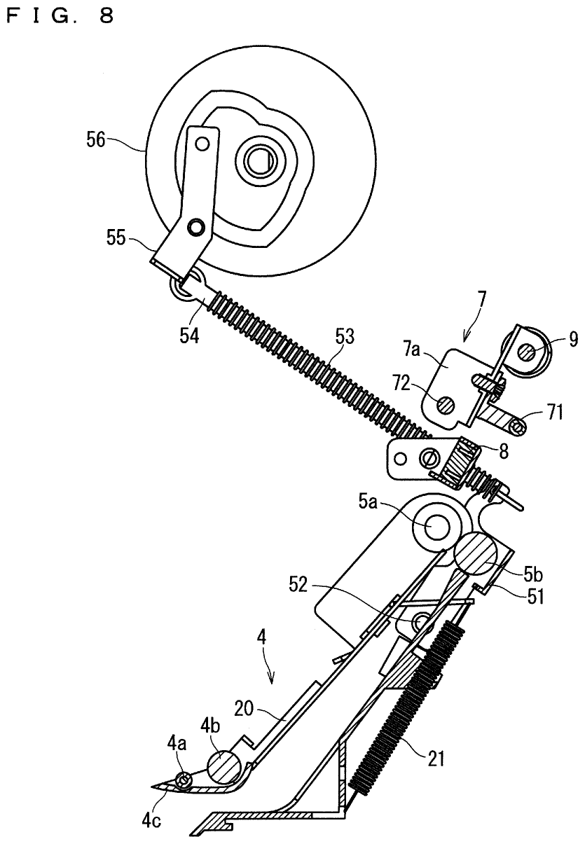

Next, the operation of each configuration described above will be described. First, the operation of the paper edge severance guide unit 4 will be described with reference to FIGS. 7 to 10. As illustrated in FIGS. 7 to 10, the urging springs 21 are attached to the guide 20 which is the first arm the paper edge severance guide unit 4 has; therefore, the guide 20 is urged in the direction to approach the rolled paper 3 by the urging springs 21. Furthermore, the large roller 4b and the small rollers 4a are provided on the severance guide 4c that is the second arm, and the severance guide 4c is swingably provided on the guide 20 that is the first arm with the axis of the large roller 4b as a swing fulcrum. Thereby, the large roller 4b and the small rollers 4a can come into contact with the rolled paper 3 even when the sheet of paper 3a is pulled out from the rolled paper 3 and the winding diameter of the rolled paper 3 changes.

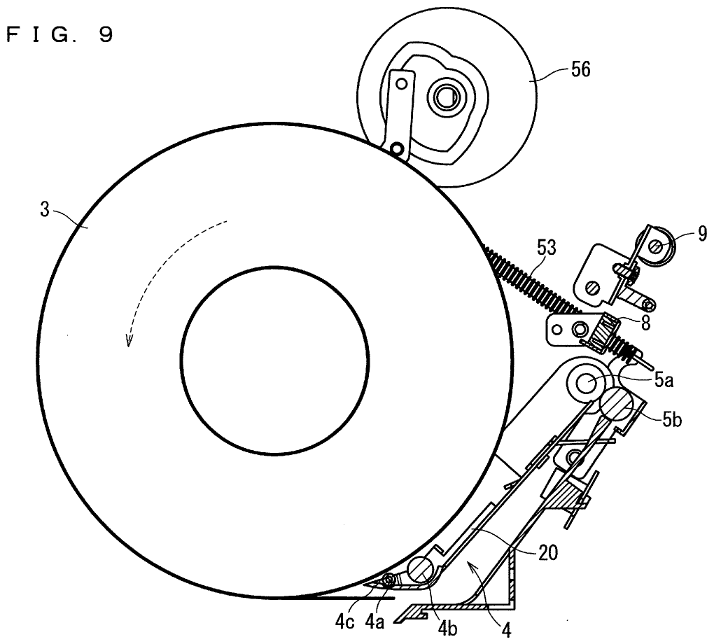

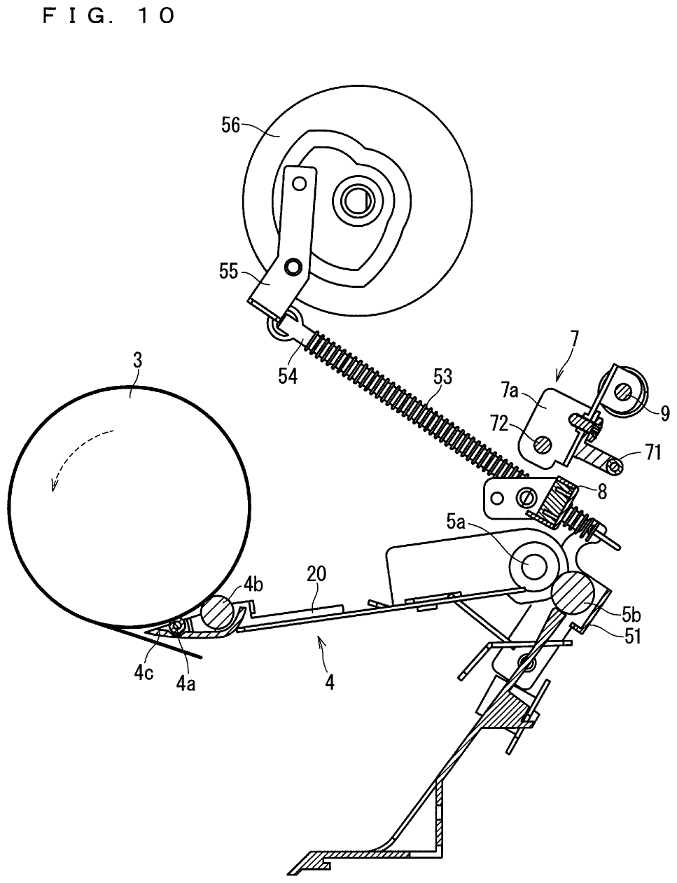

The distal end portion of the severance guide 4c has a tapered shape at the distal end portion thereof. That is, the distal end portion of the severance guide 4c is provided with inclinations in the vertical and horizontal directions. Therefore, after the user sets the rolled paper 3 and turns the rolled paper 3 by hand in the direction of the arrow in FIG. 9 and FIG. 10 (counterclockwise with respect to the paper surface), the leading edge of the sheet of paper 3a is severed from the rolled paper 3 in the roll state without being caught with the severance guide 4c, regardless of the winding diameter of the roll paper 3.

Further, the user can guide the sheet of paper 3a to the feed roller unit 5 along the back surface of the guide 20 by keeping on feeding the sheet of paper 3a. At this time, the path for transporting the sheet of paper 3a is blocked by the sheet stopper 7; therefore, the sheet of paper 3a is not fed further downstream of the path. As described above, even when the feed roller unit 5 is disposed behind the work position, the sheet of paper 3a can be readily guided. The work position refers to a position where the user turns the rolled paper 3a. Further, the user can readily know the completion of the loading of the sheet of paper 3a by recognizing that the sheet of paper 3a cannot be fed any further by the paper stopper 7.

At this time, as illustrated in FIG. 2, the sheet of paper 3a is traversing the paper feed sensor 8, the control unit 31 acquires information from the paper feed sensor 8 and causes the notification unit 11 to generate an alarm sound. The user can more readily know the completion of the loading of the sheet of paper 3a by the alarm sound.

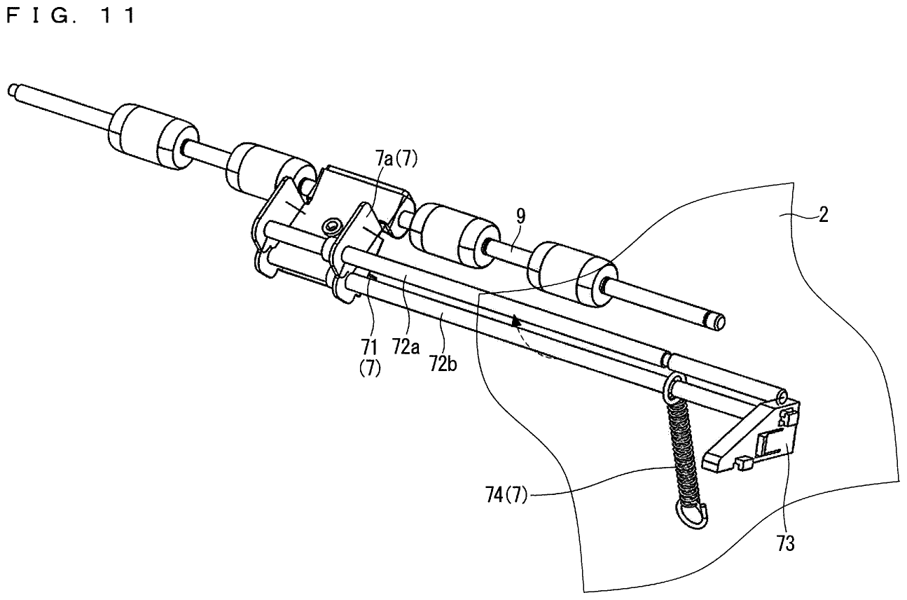

Next, the structure peripheral of the paper stopper 7 will be described with reference to FIGS. 11 to 13. As described above, the main body 7a, the small roller 71, the rotating lever 72, and the urging spring 74 are provided in the housing 1. As illustrated in FIG. 11, the slide cam 73 is provided on the housing 2, and the rotation lever 72 moves up and down along the slide cam 73. That is, as illustrated in FIG. 12, when the housing 1 is pulled out from the housing 2 to replenish the rolled paper 3, the rotating lever 72 is located below along the slide cam 73, and the main body 7a is in the state of blocking the passage for transporting the sheet of paper 3a.

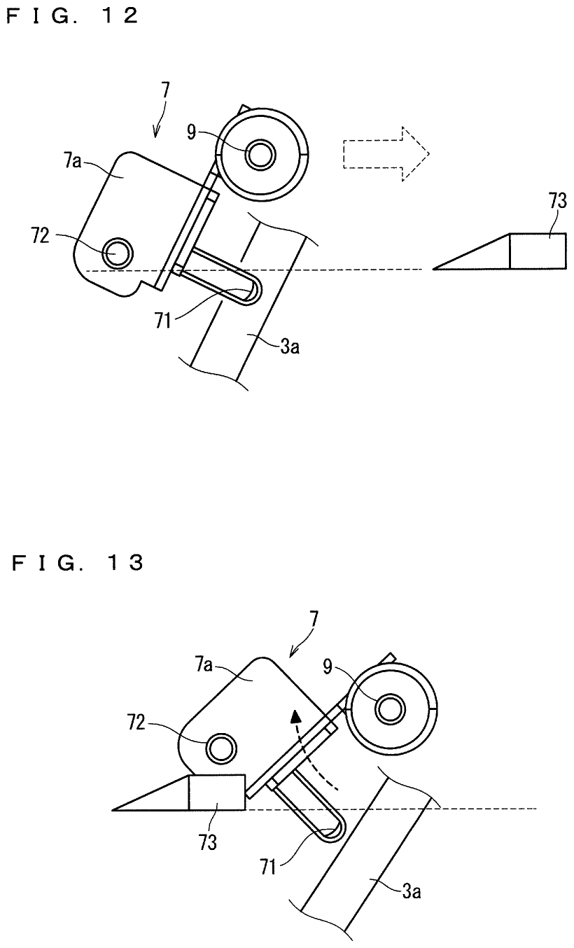

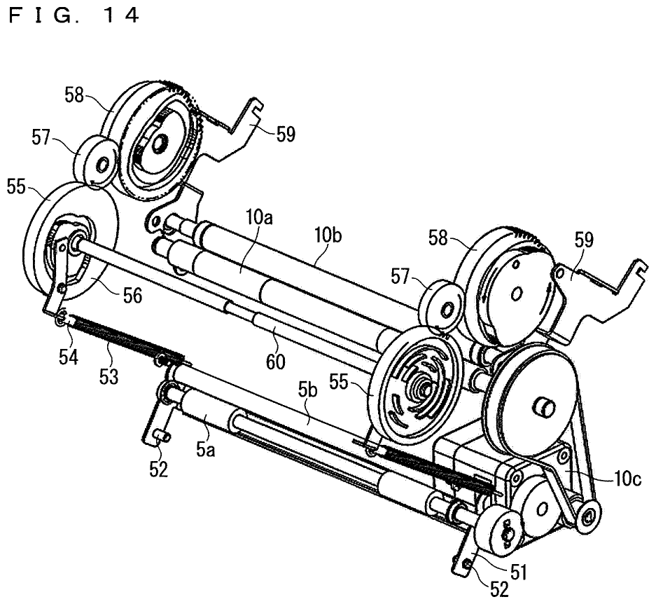

As illustrated in FIG. 13, when the housing 1 is pushed in and coupled to the housing 2, the rotating lever 72 is lifted up along the slide cam 73, so that the main body 7a is lifted upward to open the passage for transporting the sheet of paper 3a. As described above, by interlocking the vertical movement of the main body 7a with the movement of the housing 1, a low-cost structure without having individual drive sources is ensured.

Further, the small roller 71 is provided at the distal end of the main body 7a. The main body 7a is configured to be rotatable around the axis of the guide roller 9, and the rotation fulcrum is provided between the small roller 71 and the grip roller 10a. This means the structure in which, when the sheet of paper 3a is pulled out from the grip roller 10a side to the small roller 71 side, it acts in a direction the sheet of paper 3a readily pushes up the main body 7a, and conversely, when the sheet of paper 3a enters from the feed roller 5a side, the main body 7a is suppressed from being readily rotated by the sheet of paper 3a.

In this way, taking out the sheet of paper 3a can be readily done without damaging the sheet of paper 3a even if a paper jam occurs in the middle of printing and the sheet of paper 3a is left behind on the cutter 16 side with respect to the main body 7a, and, the housing 1 is pulled out in this state and the main body 7a comes down on the sheet of paper 3a.

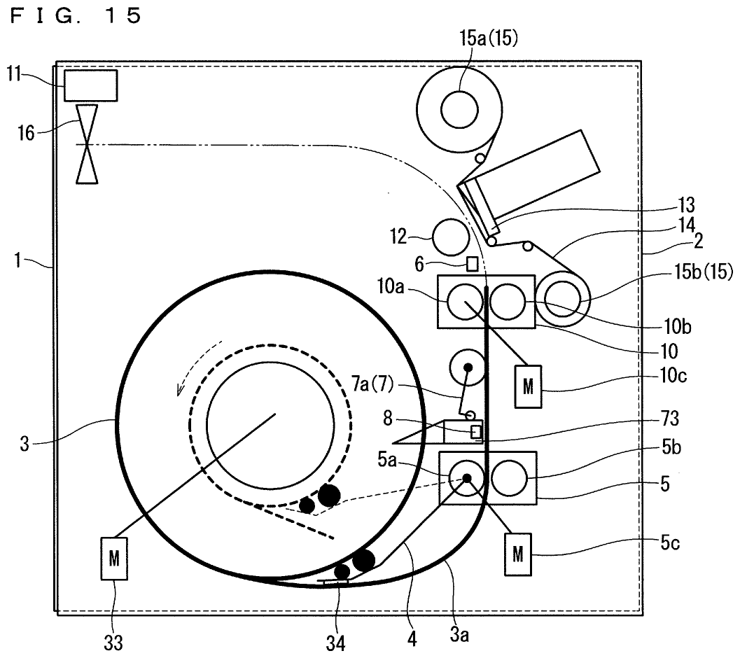

Next, an operation when gripping the sheet of paper 3a will be described with reference to FIG. 14. As illustrated in FIG. 14, the feed rollers 5a are rotatably locked, and a grip roller 5b is disposed to face the feed rollers 5a. When the cam 56 is rotated by a DC motor or the like (not shown), the rotation of the cam follower 55 causes pressing metal plates 51 to rotate around the rotation fulcrum 52 via the urging spring 53, and the grip roller 5b comes into contact with the feed rollers 5a.

The urging spring 53 is a coil spring, and a lever shaft 54 is disposed inside the urging spring 53. The length of the lever shaft 54 is such that the cam follower 55 and the pressing metal plate 51 can contact each other when the feed rollers 5a and the grip roller 5b contact each other. The lever shaft 54 is not connected to the cam follower 55 and the pressure metal plate 51.

At the time of press bonding, when the cam follower 55 is rotated as described above, the grip roller 5b is pressed by the urging spring 53 to press the feed rollers 5a with a predetermined pressing force. On the other hand, at the time of release, the lever shaft 54 pushes up the pressure metal plate 51 to release the grip roller 5b. As described above, the pinch roller 10b and the grip roller 5b can be opened using the same drive source, so that the thermal printer can be configured at low cost.

When feeding the sheet of paper 3a, the grip roller 5b is pressed and the pinch roller 10b is opened. Thereby, the sheet of paper 3a can be readily transported to the platen roller 12. At the time of printing, the grip roller 5b is opened, and the pinch roller 10b is pressed. Thus, uneven feeding by the feed rollers 5a and the grip roller 5b during printing is avoidable. At the time of moving of the sheet of paper 3a in a discharge direction, the grip roller 5b is pressed, and the pinch roller 10b is pressed. Thereby, the effect of preventing the paper 3a from being displaced when the paper 3a moves in the discharge direction is obtained.

(Effect)

As described above, the thermal printer according to Embodiment 1 includes the thermal head 13 that records an image on the sheet of paper 3a pulled out from rolled paper 3 wound in a roll shape, the platen roller 12 is disposed at a position facing the thermal head 13, and sandwiches the sheet of paper 3a with the thermal head 13, the housing 1 in which the platen roller 12 is disposed, and the housing 2 in which the thermal head 13 is disposed. The housing 1 is couple with and decouple from the housing 2, the housing 1 includes the paper edge severance guide unit 4 that severs the leading edge of the sheet of paper 3a from the rolled paper 3 in the roll state, and guides the sheet of paper 3a toward the platen roller 12, the feed rollers 5a that are disposed between the paper edge severance guide unit 4 and the platen roller 12, and performs gripping of the sheet of paper 3a and conveyance of the sheet of paper 3a in the direction of the platen roller 12, and the paper stopper 7 that is disposed between the feed rollers 5a and the platen roller 12, and blocks the passage for transporting the sheet of paper 3a in a state where the housing 1 is decoupled from the housing 2.

Therefore, the user can readily load the paper 3a pulled out from the rolled paper 3, and can readily feed the paper 3a.

The thermal printer further includes the paper feed sensor 8 that is disposed around the paper stopper 7 and detects the leading edge of the sheet of paper 3a and the notification unit 11 that notifies of completion of the feeding of the sheet of paper 3a when the paper feed sensor 8 detects the leading edge of the sheet of paper 3a.

Therefore, the user can more readily know the completion of the loading of the sheet of paper 3a by the notification by the notification unit 11.

The housing 2 includes a slide mechanism that allows the housing 1 to slidably couple to and decouple from the housing 2, the housing 2 includes the slide cam 73, the paper stopper 7 includes the small roller 71, the rotating lever 72 that can contact the slide cam 73 and switches the position of the small roller 71 with its own rotation due to sliding of the slide cam 73, and the urging spring 74 that urges the rotating lever 72 in a direction to switch the position of the small roller 71 to a position that blocks the passage. With the housing 1 coupled to the housing 2, the rotating lever 72 switches the position of the small roller 71 to a position that opens the passage.

Therefore, the user can readily bring the sheet of paper 3a into a state in which the sheet of paper 3a can be conveyed in the direction of the platen roller 12 by sliding the housing 1 to the housing 2 to couple each other.

The paper edge severance guide unit 4 includes the guide 20 that can swing around the axis of the feed rollers 5a as a swing fulcrum, the urging springs 21 that urge the guide 20 in a direction to approach the rolled paper 3, and the severance guide 4c that can swing with respect to the guide 20 to an end opposite to the swing fulcrum of the guide 20. The distal end portion of the severance guide 4c has a tapered shape at the distal end portion thereof, the severance guide 4c includes a plurality of small rollers 4a that are disposed closer to the base end portion side than the distal end portion and can contact the rolled paper 3.

Therefore, regardless of the winding diameter of the rolled paper 3, the leading edge of the paper 3a can be severed from the roll state of the rolled paper 3 without the leading edge of the paper 3a being caught by the severance guide 4c.

### Embodiment 2

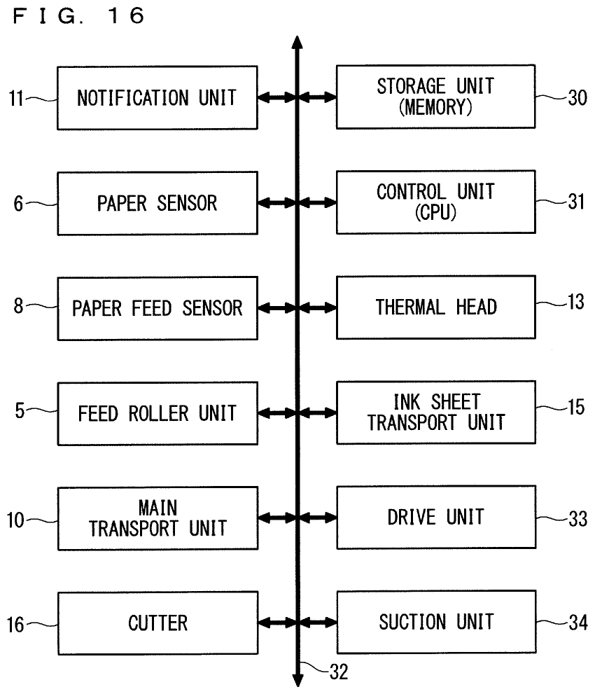

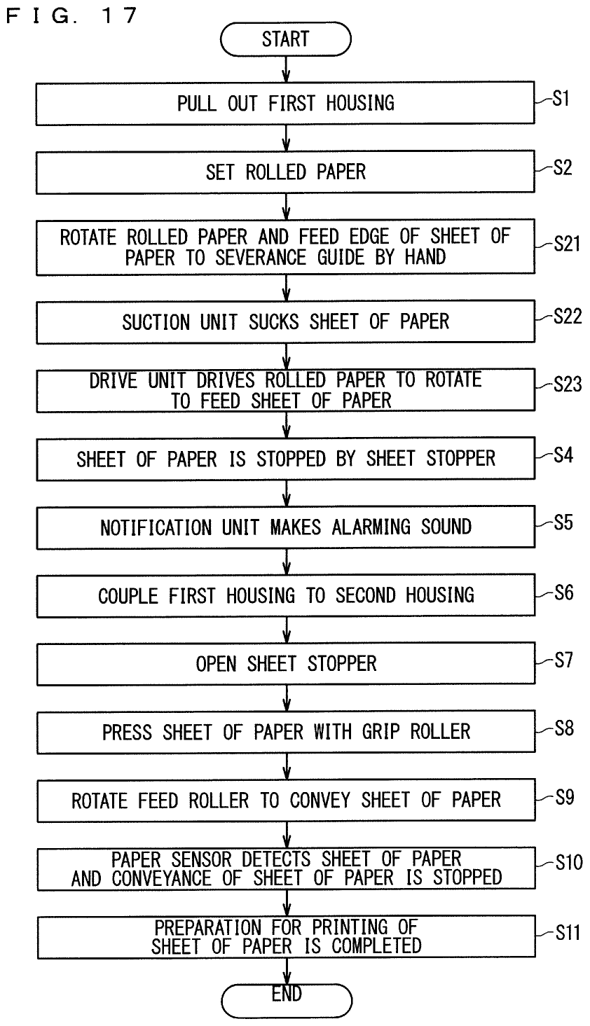

Next, the thermal printer according to Embodiment 2 will be described. FIG. 15 is an explanatory diagram of a configuration of the thermal printer according to Embodiment 2. FIG. 16 is a block diagram of the thermal printer. FIG. 17 is a flowchart of the paper feed operation of the thermal printer. In Embodiment 2, the same components as those described in Embodiment 1 are denoted by the same reference numerals, and description thereof will be omitted.

(Configuration)

The thermal printer according to Embodiment 2 includes a paper feed mechanism in which loading the rolled paper 3 can be readily performed even when the roll diameter of the rolled paper 3 is small, and the sheet of paper 3a is readily fed.

As illustrated in FIG. 15 and FIG. 16, in contrast with the configuration of Embodiment 1, the thermal printer according to Embodiment 2 further includes a drive unit 33 that rotates the rolled paper 3. Further, the paper edge severance guide unit 4 further includes a suction unit 34 for sucking the sheet of paper 3a.

The drive unit 33 drives the rolled paper 3 to rotate under the control of the control unit 31. In particular, when the roll diameter of the rolled paper 3 is small, rotating the rolled paper 3 by the human hand is not an easy task. However, the rotation of the drive unit 33 allows the sheet of paper 3a to be readily fed. The suction unit 34 is disposed on the bottom surface of the severance guide 4c which is the side where the sheet 3a passes, and generates, for example, static electricity and sucks the sheet of paper 3a to the bottom surface of the severance guide 4c.

Next, a paper feed operation flow according to Embodiment 2 will be described with reference to FIG. 17. Note that description on the same operation as the flow of the paper feed operation of Embodiment 1 will not be partially omitted.

In Embodiment 1, the sheet of paper 3a is fed to the paper stopper 7 by rotating the rolled paper 3 by hand, in Embodiment 2, as illustrated in FIG. 17, the user sets the rolled paper 3 in the first housing (Step S2), and feeds the leading edge of the sheet of paper 3a to the severance guide 4c by hand (Step S21). At this time, the suction unit 34 suctions the sheet of paper 3a to the bottom surface of the severance guide 4c (Step S22).

Thereafter, under the control of the control unit 31, the drive unit 33 feeds the sheet of paper 3a by rotating the rolled paper 3 in the direction of the arrow in FIG. 15 (counterclockwise with respect to the sheet of drawings) (Step S23), and when the leading edge of the sheet of paper 3a is detected by the paper feed sensor 8, the rolled paper 3 is temporarily stopped (Step S4). Next, the control unit 31 causes the grip roller 5b to press (Step S8), and causes the motor to rotate the feed rollers 5a, thereby the sheet of paper 3a is fed (Step S9). After the sheet of paper 3a passes between the grip roller 10a and the pinch roller 10b and the leading edge of the sheet of paper 3a is detected by the paper sensor 6, the control unit 31 stops conveying the sheet of paper 3a (Step S10), and preparation for printing of the sheet of paper 3a is completed (Step S11). Thus, the feeding of the sheet of paper 3a is completed.

(Effect)

As described above, the thermal printer according to Embodiment 2 further includes the drive unit 33 that drives the roll paper 3 to rotate, the paper edge severance guide unit 4 further includes the suction unit 34 that sucks the sheet of paper 3a, the suction unit 34 is disposed on a surface of the severance guide 4c which is the side where the sheet of paper 3a passes and sucks the sheet of paper 3a pulled out from the rolled paper 3, and prompts the sheet of paper 3a to the direction of platen roller 12, and with the housing 1 coupled to the housing 2, the drive unit 33 drives the rolled paper 3 to rotate and feeds the sheet of paper 3a in the direction of the platen roller 12 until when the leading edge of the sheet of paper 3a is detected by the paper feed sensor 8.

Therefore, even when the winding diameter of the rolled paper 3 is small, the loading of the sheet of paper 3a is readily performed without the leading edge of the sheet of paper 3a being stuck at the bottom surface of the severance guide 4c. In addition, the drive unit 33 makes the feeding of the sheet of paper 3a facilitate by driving the rolled paper 3 to rotate.

While the invention has been described in detail, the foregoing description is in all aspects illustrative and not restrictive. It is understood that numerous other modifications and variations can be devised without departing from the scope of the invention.

It should be noted that Embodiments of the present invention can be arbitrarily combined and can be appropriately modified or omitted without departing from the scope of the invention.

### EXPLANATION OF REFERENCE SIGNS

1,2 housing, 3 rolled paper, 3a sheet of paper, 4 paper edge severance guide unit, 4a small roller, 4c severance guide, 5 feed roller, 7 paper stopper, 8 paper feed sensor, 11 notification unit, 12 platen roller, 13 thermal head, 20 guide, 21 urging spring, 33 drive unit, 34 suction unit, 71 small roller, 73 slide cam, 74 urging spring

1. A thermal printer comprising:
a thermal head configured to record an image on a sheet of paper pulled out from rolled paper wound in a roll shape;
a platen roller disposed at a position facing the thermal head, and sandwiches the sheet of paper with the thermal head;
a first housing in which the platen roller is disposed; and
a second housing in which the thermal head is disposed, wherein
the first housing is capable of coupling to and decoupling from the second housing,
the first housing includes
a paper edge severance guide unit configured to sever a leading edge of the sheet of paper from a roll state of the rolled paper, and guide the sheet of paper toward the platen roller,
feed rollers disposed between the paper edge severance guide unit and the platen roller, and configured to perform gripping of the sheet of paper and conveyance of the sheet of paper in the direction of the platen roller, and
a paper blocking unit disposed between the feed rollers and the platen roller and configured to block a passage for transporting the sheet of paper in a state where the first housing is decoupled from the second housing.

2. The thermal printer according to claim 1, further comprising
a paper detection unit disposed around the paper blocking unit and configured to detect the leading edge of the sheet of paper, and a notification unit configured to notify completion of feeding of the sheet of paper when the paper detection unit detects the leading edge of the sheet of paper.

3. The thermal printer according to claim 2, wherein
the first housing includes a slide mechanism in which the first housing is allowed to slide to couple to and decouple from the second housing,
the second housing includes a slide cam,
the paper blocking unit includes a first roller, a rotating lever that can contact the slide cam and switches a position of the first roller with rotation thereof due to sliding of the slide cam, and a first urging spring that urges the rotating lever in a direction to switch the position of the first roller to a position that blocks the passage, and
with the first housing coupled to the second housing, the rotating lever switches the position of the first roller to a position that opens the passage.

4. The thermal printer according to claim 3, wherein
the paper edge severance guide unit includes a first arm that can swing around an axis of the feed rollers as a swing fulcrum, second urging springs that urge the first arm in a direction to approach the rolled paper, and a second arm that can swing with respect to the first arm to an end portion opposite to the swing fulcrum of the first arm,
the second arm has a tapered shape at a distal end portion thereof, and
the second arm includes a plurality of second rollers that are disposed closer to a base end portion side than the distal end portion and can contact the rolled paper.

5. The thermal printer according to claim 4, further comprising
a drive unit configured to drive the rolled paper to rotate, wherein
the paper edge severance guide unit further includes a suction unit configured to suck the sheet of paper,
the suction unit is disposed on a surface of the second arm which is a side where the sheet of paper passes and configured to suck the sheet of paper pulled out from the rolled paper and prompt the sheet of paper to a direction of the platen roller, and
with the first housing coupled to the second housing, the drive unit drives the rolled paper to rotate and feeds the sheet of paper in the direction of the platen roller until when the leading edge of the sheet of paper is detected by the paper detection unit.
